(19) United States
(12) Patent Application Publication
(10) Pub. No.: US 2021/0068164 A1
(43) Pub. Date: Mar. 4, 2021

(54) MOBILE STATION APPARATUS

(71) Applicants: SHARP KABUSHIKI KAISHA, Sakai City, Osaka (JP); FG Innovation Company Limited, Tuen Mun, New Territories (HK)

(72) Inventors: SEIJI SATO, Sakai City, Osaka (JP); JUNGO GOTOH, Sakai City, Osaka (JP); OSAMU NAKAMURA, Sakai City, Osaka (JP); SHOHEI YAMADA, Sakai City, Osaka (JP); YASUHIRO HAMAGUCHI, Sakai City, Osaka (JP)

(21) Appl. No.: 17/044,681

(22) PCT Filed: Apr. 4, 2019
(86) PCT No.: PCT/JP2019/014922

§ 371 Date: Oct. 1, 2020

(30) Foreign Application Priority Data
Apr. 5, 2018 (JP) 2018-073225

(51) Int. Cl. H04W 74/08; H04W 72/14; H04W 76/19

(52) U.S. Cl. CPC H04W 74/0833; H04W 76/19; H04W 72/14

(57) ABSTRACT

In a case that an uplink timing alignment timer expires, Type 1 configured uplink grants configured in all serving cells belonging to a TAG associated with the uplink timing alignment timer are suspended. A random access response including a timing advance command configured for the TAG is received. In a case that a random access preamble included in the random access response is not a contention based random access preamble, or in a case that the random access response includes the contention based random access preamble and includes information indicating successful random access contention resolution, and the timing alignment timer associated with the TAG is not running, the Type 1 configured uplink grants configured and suspended in the all serving cells belonging to the TAG are re-initialized.

### TECHNICAL FIELD

The present invention relates to a mobile station apparatus. This application claims priority based on JP 2018-073225 filed on Apr. 5, 2018, the contents of which are incorporated herein by reference.

### BACKGROUND ART

A standardization organization, 3rd Generation Partnership Project (3GPP), has standardized Evolved Universal Terrestrial Radio Access (also referred to as “EUTRA” or “LTE”), to which the third-generation mobile communication system has been evolved, and Advanced EUTRA (also referred to as “LTE-Advanced” or “LTE-A”), which is the fourth-generation mobile communication system to which EUTRA or LTE has further been evolved, and mobile communications using such specifications are commercialized across countries (NPL 1). In addition, in recent years, studies and standardization of specifications of the technology of the fifth-generation mobile communication system have progressed in 3GPP (NPL 2).

As one of scheduling (communication resource allocating) technologies, there is a method for periodical allocation of communication resources using Semi-Persistent Scheduling (SPS). Unlike dynamic scheduling in which communication resources are allocated using signaling called an uplink grant or a downlink assignment for each subframe, this is a technology in which communication resources are allocated in accordance with a predetermined configuration (a time interval, a modulation scheme, an initialization timing, the number of repetitions, and the like) to omit the uplink grant or the downlink assignment, thus enabling efficient communication by decreasing overheads caused by control signals. While the SPS has been employed also in the existing technologies of LTE and LTE-Advanced and used for real-time communications such as a communication of a voice service, studies and standardization of specifications thereof for further evolution of the SPS have progressed also in the fifth-generation mobile communication system. In addition, studies and standardization of specifications of an uplink Grant Free (GF) communication system have progressed that enables, by applying uplink SPS, uplink data transmission from a mobile station apparatus to a base station apparatus without an uplink grant allocated from the base station apparatus to the mobile station apparatus.

### CITATION LIST

### Non Patent Literature

NPL 1: “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 14)” 3GPP TS 36.300 V14.3.0 (2017-06)
NPL 2: “3rd Generation Partnership Project; Technical Specification Group Radio Access Network; NR; NR and NG-RAN Overall Description; Stage 2 (Release 15)” 3GPP TS 38.300 V15.1.0 (2018-03)

### SUMMARY OF INVENTION

### Technical Problem

There is a concern that in a case that an uplink synchronization loss occurs during GF communication, the communication is delayed, and the like.

One aspect of the present invention has been made in view of such circumstances, and an object of the present invention is to provide a mobile station apparatus and a communication method capable of decreasing a delay of communication even in a case that the uplink synchronization loss occurs during the GF communication.

### Solution to Problem

(1) One aspect of the present invention has been made to solve the above-described problems, and a mobile station apparatus according to one aspect of the present invention is a mobile station apparatus in a communication system including at least a base station apparatus and a mobile station apparatus for performing communication through carrier aggregation simultaneously using multiple serving cells configured by the base station apparatus, wherein the mobile station apparatus is configured to, in a case that an uplink timing alignment timer expires, suspend Type 1 configured uplink grants configured in all serving cells belonging to a timing advance group associated with the uplink timing alignment timer, receive a random access response including a timing advance command configured for the timing advance group, and, in a case that a random access preamble included in the random access response is not a contention based random access preamble, or in a case that the random access response includes the contention based random access preamble and includes information indicating successful random access contention resolution, and the timing alignment timer associated with the timing advance group is not running, re-initialize the Type 1 configured uplink grants configured and suspended in the all serving cells belonging to the timing advance group.

(2) A mobile station apparatus according to one aspect of the present invention is the mobile station apparatus described above configured to, in a case that the timing advance group associated with the uplink timing alignment timer is a primary timing advance group, suspend the Type 1 configured uplink grants configured in the all serving cells at a time when the uplink timing alignment timer expires.

(3) A mobile station apparatus according to one aspect of the present invention is a mobile station apparatus in a communication system at least including a base station apparatus and a mobile station apparatus for performing communication through carrier aggregation simultaneously using multiple serving cells configured by the base station apparatus, wherein the mobile station apparatus is configured to, in a case that an uplink timing alignment timer expires, notify a higher layer of release of Type 1 configured uplink grants configured in all serving cells belonging to a timing advance group associated with the uplink timing alignment timer.

(4) A mobile station apparatus according to one aspect of the present invention is the mobile station apparatus described above configured to, in a case that the timing advance group associated with the uplink timing alignment timer is a primary timing advance group, notify the higher layer of release of the Type 1 configured uplink grants configured in the all serving cells at a time when the uplink timing alignment timer expires.

### Advantageous Effects of Invention

According to one aspect of the invention, a delay of communication can be decreased even in a case that an uplink synchronization loss occurs during GF communication.

### BRIEF DESCRIPTION OF DRAWINGS

FIG. 1 is a diagram illustrating an example of a MAC entity configuration in a mobile station apparatus according to one aspect of the present invention.

FIG. 2 is a diagram illustrating an example of a flow of transmission and/or reception of a message and data between a base station apparatus and the mobile station apparatus at each point of time, and a change in a state of an uplink timing alignment timer and a state of GF in the mobile station apparatus, according to one aspect of the present invention.

### DESCRIPTION OF EMBODIMENTS

Prior to describing embodiments of the present invention, GF and SPS, cell activation/deactivation, Bandwidth Part (BWP) switching, uplink timing alignment, and random access according to one aspect of the present invention will be described.

### GF/SPS

An uplink grant for dynamic scheduling is referred to as a dynamic grant, while an uplink grant for uplink SPS or GF allows transmission using a transmission physical resource of a predetermined configuration, and thus, may also be referred to as a configured grant or a configured uplink grant. Similarly, downlink SPS performs reception using a reception physical resource of a predetermined configuration, and thus, may also be referred to as a configured assignment or a configured downlink assignment. In the specification standardization for the fifth generation mobile communication scheme of 3GPP, the specification standardization is progressed aiming at that the uplink SPS, the GF, and the downlink SPS are collectively referred to as “Transmission/Reception without dynamic scheduling”, the downlink SPS is referred to as “DL-SPS”, and the GF and the uplink SPS are referred to as “configured grant Type 1” and “configured grant Type 2”, respectively. Note that in the following description, for convenience, “configured grant Type 1” is referred to as GF, “configured grant Type 2” is referred to as UL-SPS, and the downlink SPS is referred to as DL-SPS.

GF may be activated by configuring, by higher layer such as Radio Resource Control (RRC), periodic physical channel resource allocation, a transmission initialization timing offset, the number of HARQ processes, CS-RNTI, and the like, storing the configuration, and initializing a configured uplink grant at a configured transmission initialization timing. On the other hand, UL-SPS is activated by receiving an uplink grant included in Downlink Control Information (DCI) via a Physical Downlink Control Channel (PDCCH), although a period of a physical resource, the number of HARQ processes, CS-RNTI, and the like are configured in advance from RRC. Note that, in the GF configured in a serving cell or a BWP, deactivation transition of the serving cell or inactive transition of the BWP described below suspends transmission while maintaining the configuration from the RRC. This is referred to as suspend. The subsequent active transition of the serving cell or the subsequent active transition of the BWP re-initializes the GF in a suspend state, thus allowing GF transmission again. On the other hand, the active transition of the serving cell or the inactive transition of the BWP clears the configuration for the UL-SPS, and hence even in a case that the active transition of the serving cell or the active transition of the BWP is performed subsequently, no transmission can be performed unless activation through the above-described DCI is performed.

### Cell Activation/Deactivation

In LTE and LTE-A, the configurations for the UL-SPS and the DL-SPS are allowed to be configured only in a primary cell (PCell) and a primary secondary cell (PSCell), which are referred to as special cells (SpCell), whereas in the fifth-generation communication system in 3GPP, the DL-SPS, the UL-SPS, and the GF can be configured even in a secondary cell (SCell). The secondary cell is controlled by a network to be in an active state/non-active state, and neither transmission nor reception is performed in the non-active state. The activation to cause the secondary cell to become in the active state and the deactivation to cause the secondary cell to become in the non-activate state are indicated by a SCell Activation/Deactivation MAC Control Element (CE) transmitted from a base station apparatus to a mobile station apparatus. Furthermore, each secondary cell is configured with a sCell deactivation timer (sCellDeactivationTimer). The sCell deactivation timer is started or re-started in a case that the SCell Activation/Deactivation MAC CE indicating activation or deactivation of the secondary cell is received from the base station apparatus. Moreover, the sCell deactivation timer is also re-started in a case that an uplink grant or a downlink assignment is received on a Physical Downlink Control CHannel (PDCCH) in the secondary cell, and in a case that an uplink grant or a downlink assignment for the secondary cell is received on a PDCCH in another serving cell. In a case that the sCell deactivation timer expires, the secondary cell for which the timer is configured is deactivated, and then, the control signal and data transmission on the uplink, and the control signal and data reception on the downlink are not performed at all until next activation is performed. In addition, in a case that deactivation is indicated by the Activation/Deactivation MAC CE or a release through the RRC is performed on the secondary cell associated with the sCell deactivation timer that is running, the sCell deactivation timer is stopped.

### BWP Switching

A technique for dividing a physical resource in the serving cell into multiple frequency bands and switching between the frequency bands to be used is referred to as a Bandwidth Part (BWP). In a case that multiple BWPs are configured in the serving cell and that a downlink BWP other than a default downlink BWP (or an initial downlink BWP in a case that the default downlink BWP is not configured) is in the active state, a BWP inactivity timer (bandwidthPartInactivityTimer) is configured and started. The BWP inactivity timer is restarted in a case that an uplink grant or a downlink assignment is received on a Physical Downlink Control CHannel (PDCCH) in an active downlink BWP configured with the BWP inactivity timer, but is not restarted in a case that an uplink grant or a downlink assignment for the active downlink BWP is received on a PDCCH in another serving cell. In a case that the BWP inactivity timer expires, the downlink BWP configured with the BWP inactivity timer is switched to the default downlink BWP (or the initial downlink BWP in the case that the default downlink BWP is not configured), and communication on the serving cell is continued. Note that the BWP is configured in each of the uplink and the downlink, where the uplink BWP and the downlink BWP are paired on a one-to-one basis, and in a case that the downlink BWP is switched, the uplink BWP paired with that downlink BWP is also switched. Note that the GF and the UL-SPS can be configured for each uplink BWP, and the DL-SPS can be also configured for each downlink BWP. In a case that the GF is configured for the uplink BWP in the active state and that the state of the uplink BWP is changed to be an inactive state by switching, the GF is suspended, and the suspended GF is re-initialized to be active in a case that the uplink BWP is activated subsequently.

### Uplink Timing Alignment

Serving cells having the same transmission timing of the uplink physical channel (hereinafter, abbreviated as uplink timing) can be managed by grouping called Timing Advance Group (TAG). The TAG is classified into a Primary TAG (PTAG) including one SpCell and a secondary TAG (STAG) including no SpCell. Which serving cell belongs to which TAG depends on the RRC configuration. The uplink timing alignment is performed via a Timing Advance Command (TA command) MAC CE transmitted from the base station apparatus. The TA command MAC CE includes a TAG identifier (TAG-id) and an index indicating an uplink timing alignment value, and the uplink timings of all the serving cells belonging to the TAG indicated by the TAG identifier are aligned by the uplink timing alignment value indicated by the index. A status of the uplink timing alignment is monitored using an uplink timing alignment timer (timeAlignmentTimer). The uplink timing alignment timer is associated with each TAG. In a case that the TA command MAC CE is received and the timing alignment of the TAG corresponding to the TAG identifier is performed, the uplink timing alignment timer associated with the TAG is configured with an initial value included in an RRC configuration related message, and is started or re-started. The started or re-started uplink timing alignment timer operates until being stopped or expiring after a time indicated by the initial value described above elapses. In a case that the TA command MAC CE for the TAG associated with the uplink timing alignment timer is not received during operation of the uplink timing alignment timer, and thereafter, the uplink timing alignment timer expires, it is determined that all serving cells belonging to the TAG have lost uplink synchronization, and all uplink transmissions in all serving cells belonging to the TAG are suspended and an uplink re-synchronization establishment process is performed. Note that, in a case that the uplink timing alignment timer associated with the PTAG expires, the uplink timing alignment timers associated with not only the PTAG but also all other STAGs are considered to expire, and re-synchronization establishment of the serving cells belonging to all of the TAGs is performed.

### Random Access (RA) Procedure

The uplink synchronization establishment is performed according to a random access (RA) procedure. The RA procedure includes a contention based RA procedure and a non-contention based RA procedure. Hereinafter, each procedure will be described.

### Step 1: Random Access (RA) Preamble Transmission

In a case of the contention based RA procedure, the mobile station apparatus selects a RA preamble from multiple predetermined RA preamble sequence groups and transmits the selected RA preamble to the base station apparatus. In a case of the non-contention based RA procedure, the base station apparatus selects one RA preamble not used by another mobile station apparatus from the RA preamble sequence groups not used in the contention based RA procedure and notifies the mobile station apparatus of the selected RA preamble via PDCCH or the like in advance, and the mobile station apparatus uses and transmits the notified RA preamble.

### Step 2: Random Access Response (RAR) Reception

After transmitting the RA preamble, the mobile station apparatus waits for reception of a random access response (RAR) from the base station apparatus. In a case of receiving the RAR, the mobile station apparatus checks whether an index of the RA preamble included therein is the same as an index of the RA preamble transmitted by the mobile station apparatus, and in the case that the indices are the same, the mobile station apparatus applies the uplink timing alignment in accordance with a timing advance command MAC CE included in the RAR. In the case of the non-contention based RA procedure, the RA procedure is completed at this point of time and the uplink synchronization is established. In the case of the contention based RA procedure, by taking into account a case that the RA preamble selected in step 1 contends with that of another mobile station apparatus, the process proceeds to a next step in order to resolve the contention.

### Step 3: Uplink Data Transmission

In accordance with uplink transmission scheduling information included in the RAR, the mobile station apparatus transmits information uniquely identifying the mobile station apparatus (such as an identifier, a C-RNTI, or the like in a higher layer), a higher layer message, or the like to the base station apparatus.

### Step 4: Contention Resolution

The contention is resolved by receiving the message including the information uniquely identifying the mobile station apparatus transmitted in step 3, or receiving the DCI for the C-RNTI transmitted in step 3 through the PDCCH, the contention based RA procedure is completed, and the uplink synchronization is established.

However, in the existing technology, in a case that the uplink timing alignment timer expires, the GF configured in all the serving cells belonging to the TAG associated with the uplink timing alignment timer must stop transmission and clear the saved GF configuration. After that, even in a case that the uplink synchronization re-establishment of all the serving cells belonging to the TAG is performed, reconfiguration of the GF through the RRC needs to be performed for each serving cell, thus causing a low efficiency. Also, the effect is severe in URLLC and the like, where low delay is required. Hereinafter, a solution for the above problem will be described as embodiments of the present invention.

### First Embodiment

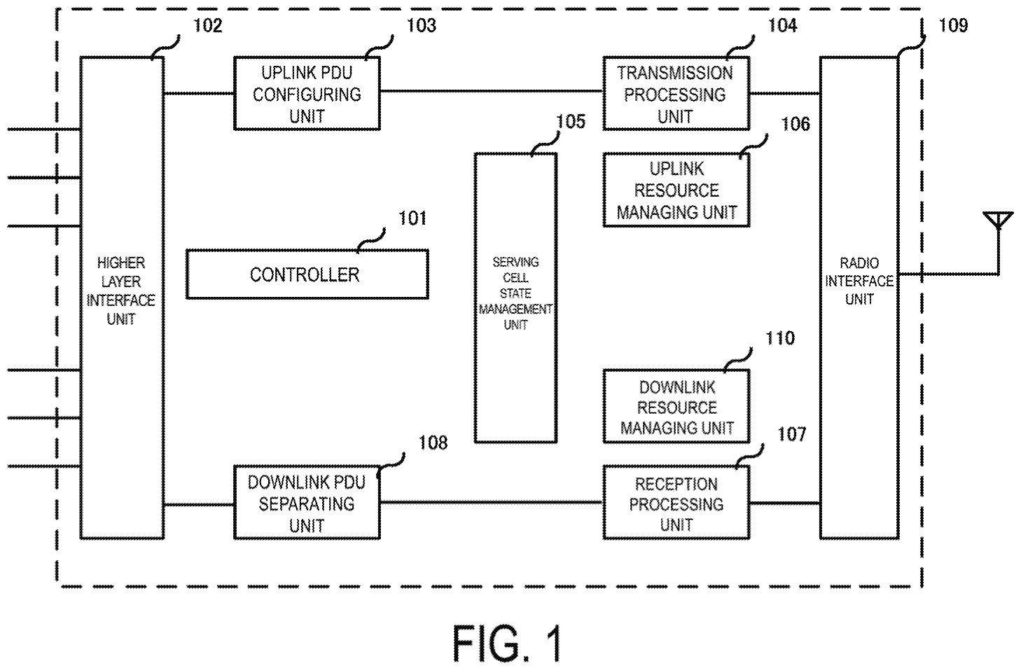

Hereinafter, a first embodiment as one aspect of the present invention will be described with reference to the drawings. FIG. 1 illustrates an example of a MAC entity configuration in a mobile station apparatus according to the present embodiment. In FIG. 1, reference sign 101 represents a controller, which controls all the components. A reference sign 102 represents a higher layer interface unit, which configures and manages logical channels with higher layers such as PDCP, RLC, and RRC, and transmits uplink data and/or receives downlink data through the logical channels. A reference sign 103 represents an uplink Protocol Data Unit (PDU) configuring unit, which configures an uplink PDU by adding a header to uplink transmission data received from a higher layer through a logical channel, combining data of the multiple logical channels, and the like. A reference sign 104 represents a transmission processing unit, which performs an error correction coding process, a modulation process, or the like on the uplink PDU generated by the uplink PDU configuring unit 103 and performs mapping to an uplink physical resource indicated from an uplink resource managing unit 106. A reference sign 105 represents a serving cell state management unit, which manages states for all the serving cells assigned to the mobile station apparatus, the uplink transmission timing, and the timing advance group (TAG). The uplink resource managing unit 106 manages uplink physical resources allocated from the base station apparatus and controls mapping of the uplink PDU to the uplink physical resource. A reception processing unit 107 reconfigures a downlink PDU by performing demodulation or decoding of an error correction code on a signal received from a radio interface unit 109. A downlink PDU separating unit 108 separates a downlink PDU received from the reception processing unit 107 into one or multiple pieces of data, transmits user data and control data to a higher layer through the higher layer interface unit 102, and transmits Control Element (CE) data to the controller 101. A reference sign 110 represents a downlink resource management unit, which manages downlink physical resources allocated from the base station apparatus. The radio interface unit 109 transmits and/or receives radio signals to and/or from the base station apparatus.

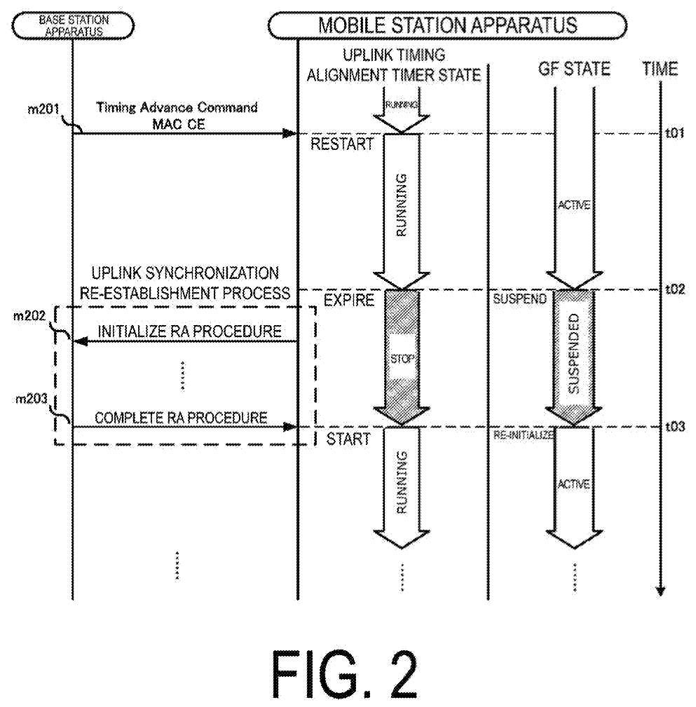

With reference to FIG. 2, a description is given of a flow of transmission and/or reception of a message and data between the base station apparatus and the mobile station apparatus at each point of time, and a change in a state of the uplink timing alignment timer and a state of GF in the mobile station apparatus, as one aspect of the present invention. First, it is assumed that the mobile station apparatus is normally connected to the base station apparatus, that the uplink timing alignment timer is running, and that the GF is also in the active state. At a time t01, the mobile station apparatus receives a TA command MAC CE m201 from the base station apparatus, aligns, in accordance with a TAG identifier and an uplink timing alignment value index included in the TA command, uplink timings of all serving cells belonging to a TAG indicated by the TAG identifier, and restarts the uplink timing alignment timer. At this time, the GF continues to be in the active state. After that, in a case that a TA command MAC CE is not received until a time t02 and the uplink timing alignment timer expires, transmissions of the uplink GF configured in all the serving cells belonging to the TAG associated with the uplink timing alignment timer are stopped and suspended. After that, the uplink re-synchronization establishment process according to the RA procedure is initialized between the mobile station apparatus and the base station apparatus (message m202). Then, in a case that the RA procedure is completed at a time t03 and the uplink synchronization is re-established, the uplink timing alignment timer is started, and all the GFs that are configured and suspended in all the serving cells belonging to the TAG associated with the uplink timing alignment timer are initialized to become in the active state, and the transmission is resumed.

Note that the completion of the RA procedure at the time t03 corresponds to the completion of the contention resolution in step 4 in the case of the contention based RA procedure, and to the reception of the RAR in step 2 in the case of the non-contention based RA procedure, as described above. In a case that the uplink timing alignment timer associated with the PTAG expires, the uplink timing alignment timers associated with not only the PTAG but also all other TAGs are determined to expire, and the GFs configured in all the serving cells are suspended. In a case that the expiration of the uplink timing alignment timer causes the uplink synchronization re-establishment process to be performed in the serving cell in which the multiple BWPs are configured, the GF configured and suspended in the UL-BWP that is activated in the re-establishment of the uplink synchronization is re-initialized.

As described above, by applying one aspect of the present invention, even in a case that an uplink synchronization loss occurs due to expiration of the uplink timing alignment timer, it is not necessary to subsequently reconfigure the GF through RRC after the uplink synchronization re-establishment, thus allowing the transmission delay to be minimized.

### Second Embodiment

Heretofore, in a case that the uplink timing alignment timer expires, the GF, UL-SPS, and DL-SPS that are configured on all the serving cells belonging to the TAG associated with the uplink timing alignment timer are cleared, but this is not notified to the higher layer such as RRC, thus, a discrepancy is caused between a MAC layer or a physical layer and the higher layer, and as a result, the reconfiguration of the GF from the RRC may not be performed or may be delayed after the uplink synchronization re-establishment. A solution for this problem will be described as a second embodiment of the present invention.

In the case that the uplink timing alignment timer associated with the PTAG expires, the RRC is notified to release all the GFs configured on all the serving cells. In the case that the uplink timing alignment timer associated with the STAG expires, the RRC is notified to release all of the GFs configured on all the serving cells belonging to the STAG.

As described above, by applying one aspect of the present invention, in the case that an uplink synchronization loss occurs in a case of expiration of the uplink timing alignment timer, notifying the RRC to release the GF allows the GF to be reconfigured and the transmission to be resumed quickly after the uplink synchronization re-establishment.

Note that the communication system, the base station apparatus, the mobile station apparatus, and the communication method to which the present invention is applied may be applied to communication standards used in other communication systems without being limited to the fifth-generation communication standard in 3GPP.

In addition, a program used for realizing all or some of the functions of the mobile station apparatus and the base station apparatus described above may be recorded on a computer-readable recording medium, and the processing of each unit may be performed by causing a computer system to read and execute the program recorded on the recording medium. The “computer system” here includes an OS and hardware components such as a peripheral device.

Further, the “computer system” includes an environment for supplying a home page (or environment for display) in a case that a WWW system is utilized.

Furthermore, the “computer-readable recording medium” refers to a portable medium such as a flexible disk, a magneto-optical disk, a ROM, a CD-ROM, and the like, and a storage device built into the computer system such as a hard disk. Moreover, the “computer-readable recording medium” may include a medium, such as a communication line that is used to transmit the program via a network such as the Internet or via a communication line such as a telephone line, that dynamically retains the program for a short period of time, and a medium, such as a volatile memory within the computer system which functions as a server or a client in that case, that retains the program for a fixed period of time. Furthermore, the above-described program may be one for realizing some of the above-described functions, and also may be one capable of realizing the above-described functions in combination with a program already recorded in a computer system.

Furthermore, all or some of the functions of the mobile station apparatus and the base station apparatus may be realized by aggregating the functions into an integrated circuit. Each functional block may be individually realized as chips, or may be partially or completely integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

The embodiments of the present invention have been described in detail above referring to the drawings, but the specific configuration is not limited to the embodiments and includes, for example, an amendment to a design that falls within the scope that does not depart from the gist of the present invention.

### INDUSTRIAL APPLICABILITY

The present invention is preferable for use in wired and wireless communication systems or communication apparatuses.

1. A mobile station apparatus in a communication system including at least a base station apparatus and a mobile station apparatus for performing communication through carrier aggregation simultaneously using multiple serving cells configured by the base station apparatus, wherein
the mobile station apparatus is configured to
in a case that an uplink timing alignment timer expires, suspend Type 1 configured uplink grants configured in all serving cells belonging to a timing advance group associated with the uplink timing alignment timer,
receive a random access response including a timing advance command configured for the timing advance group, and
in a case that a random access preamble included in the random access response is not selected from a contention based random access preamble, or
in a case that the random access response includes the contention based random access preamble and includes information indicating successful random access contention resolution, and the uplink timing alignment timer associated with the timing advance group is not running,
re-initialize the Type 1 configured uplink grants configured and suspended in the all serving cells belonging to the timing advance group.

2. The mobile station apparatus according to claim 1, wherein
the mobile station apparatus is further configured to
in a case that the timing advance group associated with the uplink timing alignment timer is a primary timing advance group,
suspend the Type 1 configured uplink grants configured in the all serving cells at a time when the uplink timing alignment timer expires.

3. A mobile station apparatus in a communication system at least including a base station apparatus and a mobile station apparatus for performing communication through carrier aggregation simultaneously using multiple serving cells configured by the base station apparatus, wherein
the mobile station apparatus is configured to
in a case that an uplink timing alignment timer expires, notify a higher layer of release of Type 1 configured uplink grants configured in all serving cells belonging to a timing advance group associated with the uplink timing alignment timer.

4. The mobile station apparatus according to claim 3, wherein
the mobile station apparatus is further configured to
in a case that the timing advance group associated with the uplink timing alignment timer is a primary timing advance group, notify the higher layer of release of the Type 1 configured uplink grants configured in the all serving cells at a time when that the uplink timing alignment timer expires.
